(19) United States
(12) Patent Application Publication
(10) Pub. No.: US 2005/0198092 A1
(43) Pub. Date: Sep. 8, 2005

(54) Fast fourier transform circuit having partitioned memory for minimal latency during in-place computation

(76) Inventors: Jia-Pei Shen, Kaohsiung (TW); Chien-Meen Hwang, San Jose, CA (US); Chih (Rex) Hsueh, Cupertino, CA (US); Orlando Canelones, Pflugerville, TX (US)

Correspondence Address: MANELLI DENISON & SELTER, 2000 M STREET NW SUITE 700, WASHINGTON, DC, 20036-3307, US

(21) Appl. No.: 10/790,205

(22) Filed: Mar. 2, 2004

(51) Int. Cl. G06F 15/00

(52) U.S. Cl. 708/404

(57) ABSTRACT

An FFT circuit is implemented using a radix-4 butterfly element and a partitioned memory for storage of a prescribed number of data values. The radix-4 butterfly element is configured for performing an FFT operation in a prescribed number of stages, each stage including a prescribed number of in-place computation operations relative to the prescribed number of data values. The partitioned memory includes a first memory portion and a second memory portion, and the data values for the FFT circuit are divided equally for storage in the first and second memory portions in a manner that ensures that each in-place computation operation is based on retrieval of an equal number of data values retrieved from each of the first and second memory portions.

### BACKGROUND OF THE INVENTION

1. Field of the Invention

The present invention relates to implementation of a Fast Fourier Transform (FFT) circuit in a real-time system, for example an IEEE 802.11a based Orthogonal Frequency Division Multiplexing (OFDM) receiver.

2. Background Art

The Fast Fourier Transform (FFT) and Inverse Fast Fourier Transform (IFFT) has been frequently applied in modem communication systems due to its efficiency in OFDM systems such as xDSL modems, high definition television (HDTV), and wireless local area networking applications. Examples of wireless local area networking applications include wireless LANs (i.e., wireless infrastructures having fixed access points), mobile ad hoc networks, etc. In particular, the IEEE Standard 802.11a, entitled “Wireless LAN Medium Access Control (MAC) and Physical Layer (PHY) specifications: High-speed Physical Layer in the 5 GHz Band”, specifies an OFDM PHY for a wireless LAN with data payload communication capabilities of up to 54 Mbps. The IEEE 802.11a Standard specifies a PHY system that uses fifty-two (52) subcarrier frequencies that are modulated using binary or quadrature phase shift keying (BPSK/QPSK), 16-quadrature amplitude modulation (QAM), or 64-QAM.

A fundamental computational element of the FFT is the “butterfly element”, which in its simplest form (radix-2) transforms two complex values into two other complex values. The butterfly element is used to perform multiple calculations in the different stages of the transform, resulting in synthesis from the time domain to the frequency domain or vice versa.

The substantial number of calculation operations performed by the butterfly element requires highly efficient designs in order to be viable in a real-time system such as wireless LANs. For example, Radix-4 butterfly elements, having four (4) inputs and four (4) outputs, are used to reduce the number of multiplication operations required during FFT processing. The higher radix butterfly element enables a reduction in memory access rate, arithmetic workload, and hence the power consumption. Efficient memory allocation also is an important consideration: in-place computation has been used to reduce memory requirements by overwriting input values (e.g., in the time domain) supplied to the butterfly element with the respective output values (e.g., in the frequency domain) generated by the butterfly element.

The use of a butterfly element, however, requires a substantial number of repeated memory read and write operations for retrieval of input values and storage of output values. Hence, arbitrary techniques for implementing an FFT architecture may result in inefficient use of memory, requiring substantial memory controller resources that increases circuit cost and/or reduces performance of the FFT circuit.

### SUMMARY OF THE INVENTION

There is a need for an arrangement that enables an FFT circuit to be implemented in a manner that provides minimal latency, optimal memory utilization and power efficiency.

There also is a need for an arrangement that provides optimal utilization of a butterfly element in an FFT circuit, with minimal idle time.

There also is a need for an arrangement that enables a wireless transceiver to perform equalization of a received frequency-modulated signal with minimum equalization error.

These and other needs are attained by the present invention, where an FFT circuit is implemented using a radix-4 butterfly element and a partitioned memory for storage of a prescribed number of data values. The radix-4 butterfly element is configured for performing an FFT operation in a prescribed number of stages, each stage including a prescribed number of in-place computation operations relative to the prescribed number of data values. The partitioned memory includes a first memory portion and a second memory portion, and the data values for the FFT circuit are divided equally for storage in the first and second memory portions in a manner that ensures that each in-place computation operation is based on retrieval of an equal number of data values retrieved from each of the first and second memory portions.

One aspect of the present invention provides a method in a Fast Fourier Transform (FFT) circuit having at least a Radix-4 (or higher) butterfly element. The method includes storing first and second equal portions of a prescribed number of data values in first and second memory portions, respectively, according to a prescribed mapping that ensures the first and second memory portions are accessed for each in-place computation operation. The method also includes executing a prescribed number of FFT stages each having a prescribed number of the in-place computation operations relative to the prescribed number of data values. The executing step includes performing each in-place computation operation by: (1) concurrently accessing an equal number of stored data values from the first memory portion and the second memory portion; and (2) supplying the accessed data values to the at least Radix-4 butterfly element for calculation of respective calculation results.

Another aspect of the present invention provides a Fast Fourier Transform (FFT) circuit. The FFT circuit includes at least a Radix-4 (or a higher Radix) butterfly element configured for generating calculation results in response to receipt of accessed data values, first and second memory portions, and a memory controller. The first and second memory portions are configured for storing first and second equal portions of a prescribed number of data values for in-place computation operations. The memory controller is configured for storing the first and second equal portions of the prescribed number of data values in the first and second memory portions, respectively, according to a prescribed mapping that ensures the first and second memory portions are accessed for each in-place computation operation. The memory controller also is configured for executing a prescribed number of FFT stages, each having a prescribed number of the in-place computation operations relative to the prescribed number of data values, based on: (1) concurrently accessing an equal number of stored data values from the first memory portion and the second memory portion; and (2) supplying the accessed data values to the at least Radix-4 butterfly element for calculation of the respective calculation results.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed in the appended claims.

### BRIEF DESCRIPTION OF THE DRAWINGS

Reference is made to the attached drawings, wherein elements having the same reference numeral designations represent like elements throughout and wherein:

FIG. 1 is a diagram illustrating a Fast Fourier Transform (FFT) circuit having first and second memory portions according to an embodiment of the present invention.

FIG. 2 is a diagram illustrating a 3-stage FFT calculation performed by the FFT circuit of FIG. 1, using an equal number of stored data values from each of the first and second memory portions for each in-place computation operation, according to an embodiment of the present invention.

FIGS. 3A and 3B are diagrams illustrating alternative methods of performing the 3-stage FFT calculation of FIG. 2.

FIGS. 4A and 4B are timing diagrams illustrating memory read and write operations executed by the memory controller in performing the 3-stage FFT calculation according to the in-place computation sequence of FIGS. 3A and 3B, respectively.

FIG. 5 is a diagram illustrating implementation of the FFT circuit of FIG. 1.

### BEST MODE FOR CARRYING OUT THE INVENTION

### Memory Partition Strategy for FFT

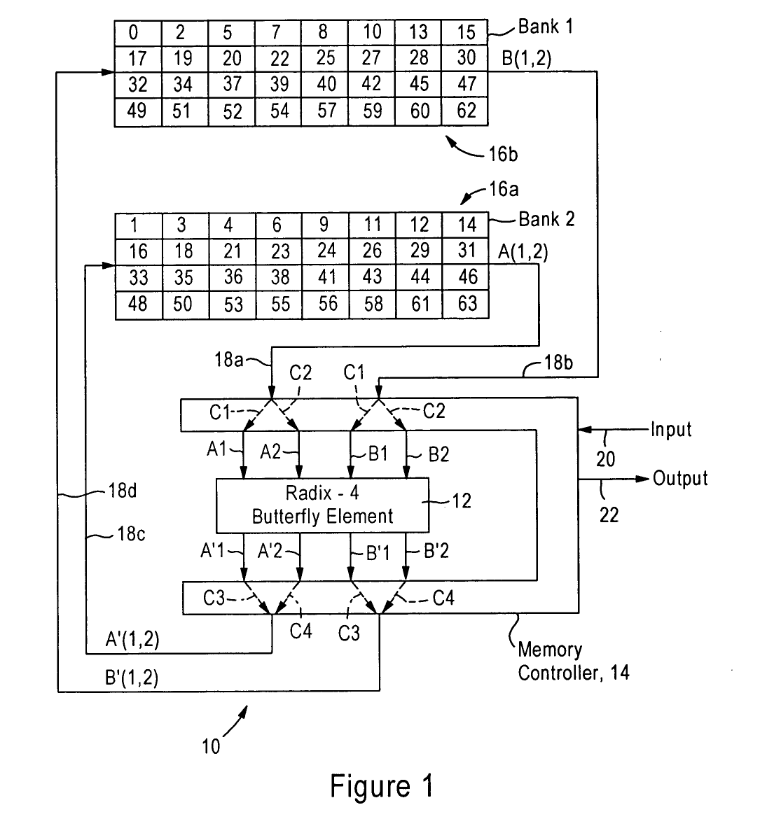

FIG. 1 is a diagram illustrating a Fast Fourier Transform (FFT) circuit 10 configured for performing either a Fast Fourier Transform (FFT) or an inverse FFT (iFFT) on a prescribed number of data values, according to an embodiment of the present invention. The FFT circuit 10 includes a Radix-4 butterfly element 12, a memory controller 14, and memory portions (i.e., memory banks) 16a and 16b.

The Radix-4 butterfly element 12 is configured for concurrently receiving four inputs (A1, A2, B1, B2) and generating and concurrently outputting four calculation results (A′1, A′2, B′1, B′2), according to known Radix-4 butterfly operations for performing FFT calculations.

The memory portions 16a and 16b are configured for storing equal portions of a prescribed number of data values for in-place computation operations. In particular, assuming a 64-point FFT is to be generated, each memory portion 16a and 16b is configured for storing half of the input points, such that in this case each memory portion stores thirty-two (32) points.

As described below, the memory controller 14 is configured for initially storing the 64-point data values into the memory banks 16a and 16b according to a prescribed mapping that ensures each of the memory banks 16a and 16b are accessed for each in-place computation operation.

As illustrated in FIG. 1, the memory controller 14 is configured for receiving sixty-four (64) data values as the prescribed number of data values from an input supply path 20, and initially storing the 64 data points according to a prescribed mapping. As illustrated in FIG. 1, the prescribed mapping of data points to memory banks 16a and 16b by the memory controller 14 is as follows:
Memory Bank 1 (16b) stores the following points: 0, 2, 5, 7, 8, 10, 13, 15, 17, 19, 20, 22, 25, 27, 28, 30, 32, 34, 37, 39, 40, 42, 45, 47, 49, 51, 52, 54, 57, 59, 60, 62; and
Memory Bank 2 (16a) stores the following points: 1, 3, 4, 6, 9, 11, 12, 14, 16, 18, 21, 23, 24, 26, 29, 31, 33, 35, 36, 38, 41, 43, 44, 46, 48, 50, 53, 55, 56, 58, 61, 63.

The memory controller 14 maintains this prescribed mapping of data points using in-place computation. Consequently, memory access is optimized by ensuring that both memory banks 16a and 16b are concurrently accessed for each read operation, and that both memory banks 16a and 16b are concurrently accessed for each write operation. Further, memory portions 16a and 16b are configured as dual port memory devices, enabling concurrent read and write operations for the memory banks 16a and 16b (i.e., performed in parallel). Hence, all of the data paths 18a, 18b, 18c, and 18d can be utilized at the same time during a given clock cycle, optimizing memory utilization and minimizing latency.

The memory controller 14 is configured for implementing in-place computations by supplying the four inputs (A1, A2, B1, B2) to the butterfly element 12, and transferring the four outputs (A′1, A′2, B′1, B′2) from the butterfly element 12 to the memory portions 16a and 16b. In particular, the memory controller 14 is configured for retrieving, each clock cycle, a data value (A) from the memory portion (“Bank 2”) 16a and concurrently a data value (B) from the second memory portion (“Bank 1”) 16b via data paths 18a and 18b, respectively. The memory controller 14 also is configured for storing, each clock cycle, a calculation result (A′) to the first memory portion 16a and concurrently a calculation result (B′) to the second memory portion 16b via data paths 18c and 18d, respectively.

For example, the memory controller 14 is configured for concurrently retrieving the stored data values A1 and B1 from the respective memory portions 16a and 16b during clock cycle C1, and retrieving the stored data values A2 and B2 from the respective memory portions 16a and 16b during clock cycle C2; the memory controller 14 buffers the accessed data values A1 and B1 retrieved during the first clock cycle C1, enabling the four inputs A1, A2, B1 and B2 to be supplied in parallel during the clock cycle C2 to the butterfly element 12. The calculation results A′1, A′2, B′1, and B′2 are output in parallel by the butterfly element 12.

As described below, the memory controller 14 completes the in-place computation by outputting the calculation results A′1, A′2, B′1, B′2 to the address locations corresponding to the original inputs A1, A2, B1, B2.

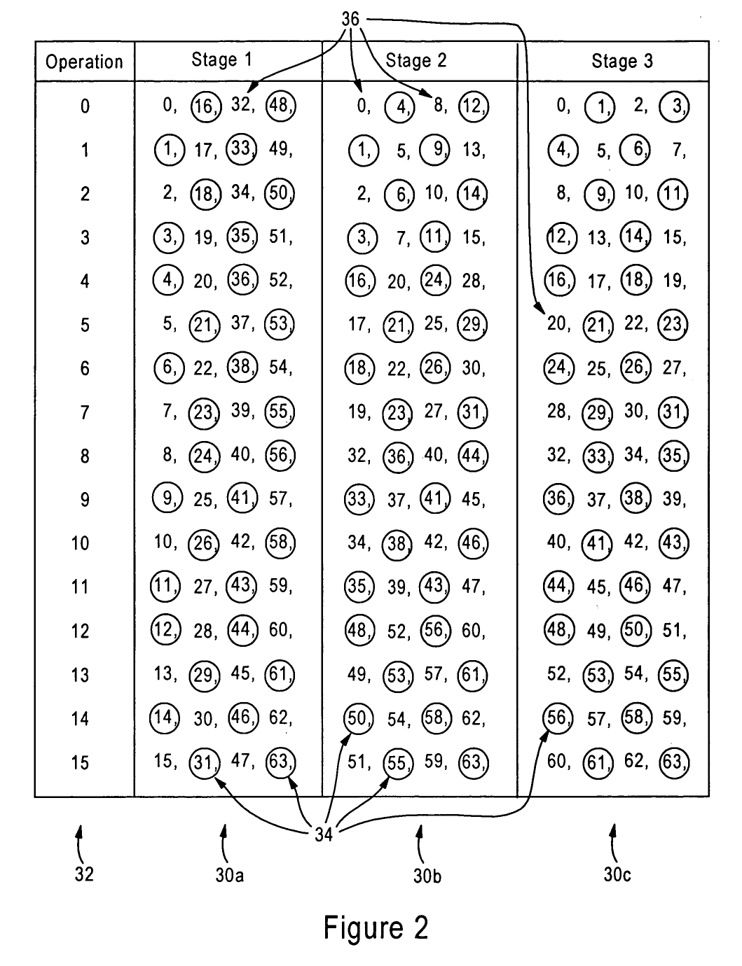

FIG. 2 is a diagram illustrating a 3-stage FFT calculation performed by the FFT circuit 10, using an equal number of stored data values from each of the first and second memory portions 16a and 16b, for each in-place computation operation, according to an embodiment of the present invention. As illustrated in FIG. 2, the FFT calculation by the FFT circuit 10 is performed in three stages 30a, 30b, and 30c, where each stage includes sixteen (16) operations 32. For example, the Radix-4 butterfly element 12 executes Stage 1, Operation 0 (S1_Op0) based on the memory controller 14 retrieving and supplying the four data points “0”, “16”, “32”, and “48” as the inputs B1, A1, B2, A2 to the butterfly element 12. In-place computation is implemented by the memory controller 14 storing the calculation results B′1, A′1, B′2, and A′2 in the same respective memory locations utilized for the original data points “0”, “16”, “32”, and “48”.

As illustrated in FIG. 2, each data point having a circle 34 is stored in the first memory bank (“Bank 2”) 16a, and each uncircled data point 36 is stored in the second memory bank (“Bank 1”) 16b. Hence, each computation operation 32 for each stage 30a, 30b, and 30c includes an equal number of data points retrieved from the first memory portion (Bank 2) 16a and the second memory portion (Bank 1). Hence, the prescribed mapping of the data points into the memory banks 16a and 16b ensures that the first and second memory banks 16a and 16b are accessed for each in-place computation operation.

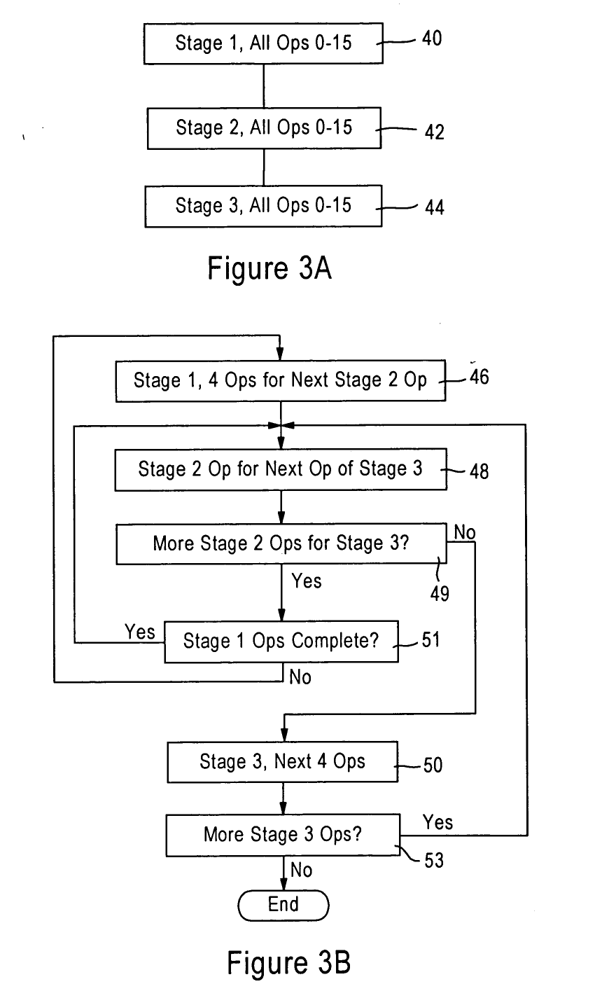

FIGS. 3A and 3B are diagrams illustrating alternative methods of performing the 3-stage FFT calculation of FIG. 2. FIG. 3A illustrates sequential execution of the operations for each stage, where the memory controller 14 is configured for supplying the data values in a per-stage sequence. In particular, the memory controller 14 causes in step 40 the execution of all Stage 1 operations (S1_Op0 through S1_Op15) 30a before beginning the second stage operations 30b in step 42. Hence, the Stage 2 operations (S2_Op0 through S1_Op15) 30b are initiated in step 42 after having completed the prescribed order of in-place Stage 1 computation operations 30a. After the Stage 2 operations 30b are completed in step 42, the memory controller 14 initiates the Stage 3 operations 30c in step 44.

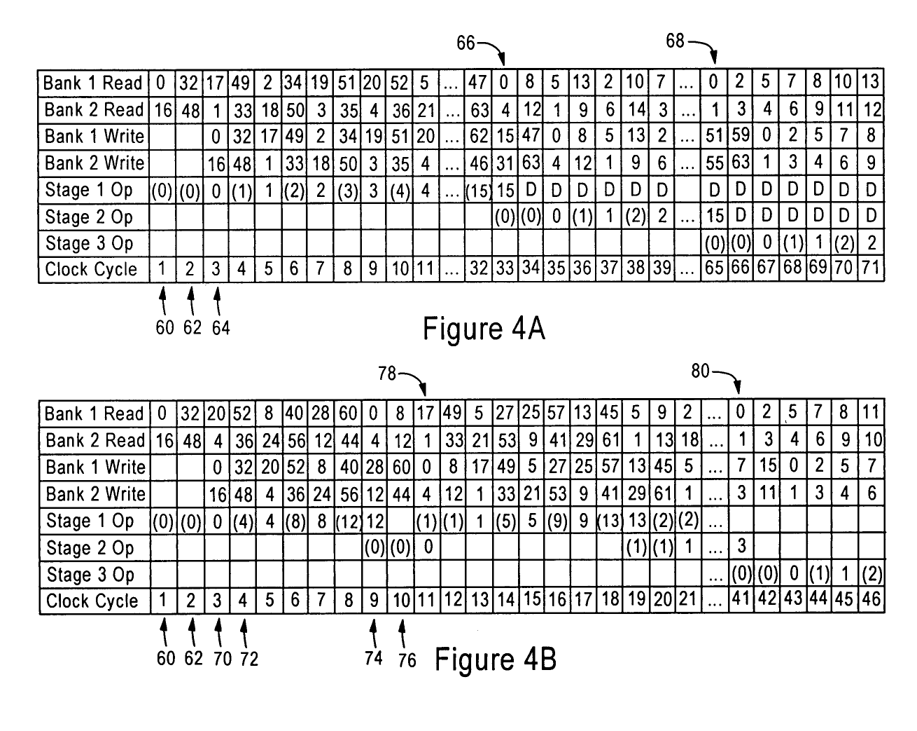

FIG. 4A is a timing diagram illustrating execution of the 3-stage FFT according to the method of FIG. 3A. As shown in FIG. 4A, the memory controller 14 concurrently accesses at event 60 (clock cycle 1) the stored data values for data point “0” and “16” from memory Bank 1 16b and Bank 2 16a, respectively, for execution of Stage 1, Operation 0: any operation in parenthesis (e.g., “(0)” at clock cycles 1 and 2) denotes the next operation to be performed by the butterfly element 12. At event 62 (clock cycle 2), the memory controller 14 concurrently accesses the stored data values for data point “32” and “48” from Bank 1 16b and Bank 16a, respectively, and supplies the retrieved values as inputs A1, A2, B1, B2. The butterfly element 12 executes the Stage 1, Operation 0 (S1_Op0) at event 64 (clock cycle 3) and outputs the resulting products A′1, A′2, B′1, B′2.

During event 64 (clock cycle 3), the memory controller 14 concurrently: stores the resulting product B′1 to the location for data point “0” in Bank 1 16b; stores the resulting product A′1 to the location for data point “16” in Bank 2 16a; retrieves the data value “17” from Bank 1 16b for execution of Stage 1, Operation 1 (S1_Op1); and retrieves the data value “1” from Bank 2 16a for execution of Stage 1, Operation 1 (S1_Op1). The memory controller 14 continues accessing the memory banks 16a and 16b for sequential execution of the Stage 1 operations 30a.

At event 66 (clock cycle 33), the butterfly element executes the last Stage 1 operation (S1_Op15) and outputs the calculation results for data points “15”, “31”, “47”, “63”. During event 66 the memory controller 14 stores the calculation results for data points “15” and “31” in Bank 1 and Bank 2, respectively, and accesses the stored data values “0” and “4” from Bank 1 and Bank 2, respectively, for initiating execution of the Stage 2 operation (S2_Op2) in step 42. The “D” reference in FIGS. 4A and 4B denote that the corresponding Stage is “done”.

The butterfly element 12 executes the last Stage 2 operation (S2_Op15) at event 68 (clock cycle 65), and the memory controller 14 concurrently stores the resulting products and retrieves the inputs as described above for initiation of stage 3 operations in step 44.

FIG. 3B illustrates input sequence-based execution of the operations 32, where selected Stage 1 operations 30a are performed in order to enable execution of Stage 2 operations 30b. For example, the Stage 2 Operation (S2_Op0) specifies an input sequence of “0”, “4”, “8”, and “12”; hence, the in-place Stage 1 operations S1_Op0 (0, 16, 32, 48), S1_Op4 (4, 20, 36, 52), S1_Op8 (8, 24, 40, 56), and S1_Op12 (12, 28, 44, 60) are performed by the memory controller 14 in step 46 in order to enable initiation of the Stage 2 Operation (S2_Op0) in step 48. After execution of the Stage 2 operation 30b in step 48, the input sequence for the next Stage 2 operation 30b is executed in step 46 by executing the associated Stage 1 operations 30a.

Note that the sequence of Stage 2 operations also can be selected based on execution of a Stage 3 operation: as illustrated in FIG. 2, the Stage 3 Operation (S3_Op0) specifies an input sequence of “0”, “1”, “2”, “3”; hence, the execution of Stage 3, Operation 0 (S3_Op0) is based on execution of the in-place Stage 2 operations S2_Op0, S2_Op1, S2_Op2, and S2_Op3. As apparent from the foregoing, execution of a Stage 2 operation 30b requires completion of the associated four Stage 1 operations 30a. Hence, if in step 49 additional Stage 2 operations need to be performed for the next Stage 3 operation, and if in step 51 the Stage 1 operations are not complete, then the associated Stage 1 operations are executed by repeating step 46.

Hence, after the memory controller 14 has completed execution in steps 48 and 49 of four (4) Stage 2 operations associated with a Stage 3 operation, e.g., S2_Op0, S2_Op1, S2_Op2, and S2_Op3, (at which point all Stage 1 operations 30a have been completed), then the memory controller 14 can initiate four (4) Stage 3 operations (S3_Op0) in step 50. Assuming in step 53 that more Stage 3 operations need to be executed, the Stage 2 operations 30b can then be completed in groups of 4, followed by execution of the associated Stage 3 operations 30c.

FIG. 4B is a timing diagram illustrating execution according to FIG. 3B. Following events 60 and 62 in preparation of execution of Stage 1, Operation 0, the memory controller accesses in events 70 and 72 the data values for execution of Stage 1, Operation 4; the memory controller 14 continues to retrieve data values according to the sequence needed for execution of Stage 2, Operation 0, namely S1_Op0, S1_Op4, S1_Op8, S1_Op12. At event 74, after the butterfly element 12 has executed the Stage 1 operations “0”, “4”, “8”, and “12”, the memory controller 14 retrieves the data values for the Stage 1 results “0”, “4”, “8”, and “12” at events 74 and 76 for execution of Stage 2, Operation 0 at event 78. Hence, the memory controller 14 can alternate between execution of Stage 1 operations 30a and Stage 2 operations 30b without any loss of efficiency in the data paths 18a, 18b, 18c, and 18d. After execution of the Stage 2 operations “0”, “1”, “2”, “3” at event 80, and having thus completed all Stage 1 operations 30a, the memory controller 14 can begin alternating execution of Stage 2 and Stage 3 operations.

As illustrated in FIGS. 4A and 4B, the memory controller 14 optimizes use of the data paths 18a, 18b, 18c, and 18d, ensuring read and write operations of the memory portions 16a and 16b are optimized, enabling complete 64-point FFT calculation within ninety-seven (97) clock cycles. After completion of the Stage 3 operations, the memory controller 14 outputs the 64-point FFT spectrum via an output path 22, illustrated in FIG. 1.

Although the disclosed embodiment utilizes a Radix-4 butterfly, it will be appreciated that other higher-order (e.g., Radix-8) butterfly elements also may be used with appropriate modification to the memory controller.

### Implementation of Memory Partition

We assume an address index a[5:0], where a[0] is the least significant bit, for the data that needs to be accessed during a read or write operation of 64-point FFT. An exclusive OR operation is used to identify the memory bank: if F(a)=XOR(a[4], a[2], a[0])=0, then memory bank 1 is the corresponding memory, and the actual address inside memory bank 1 is a[5:1]; if XOR(a[4], a[2], a[0])=1, then memory bank 2 is the corresponding memory, and the actual address inside memory bank 2 is a[5:1]. The actual address in the selected memory is obtained from the first five (5) bits of the address without memory partition. Hence, the address values A11, A12, and would have the following mappings:
A11=11 (decimal)=001011 (binary); F(A11)=1; A11 maps to address 5 of memory bank 2;
A12=12 (decimal)=001100 (binary); F(A12)=1; A12 maps to address 6 of memory bank 2;
A13=13 (decimal)=001101 (binary); F(A13)=0; A13 maps to address 6 of memory bank 1;

An alternative implementation of the memory controller 14 would be to use a look-up table to specify which memory each data value belongs to and its associated memory index (i.e., memory address within the memory bank).

### Implementation of FFT Circuit

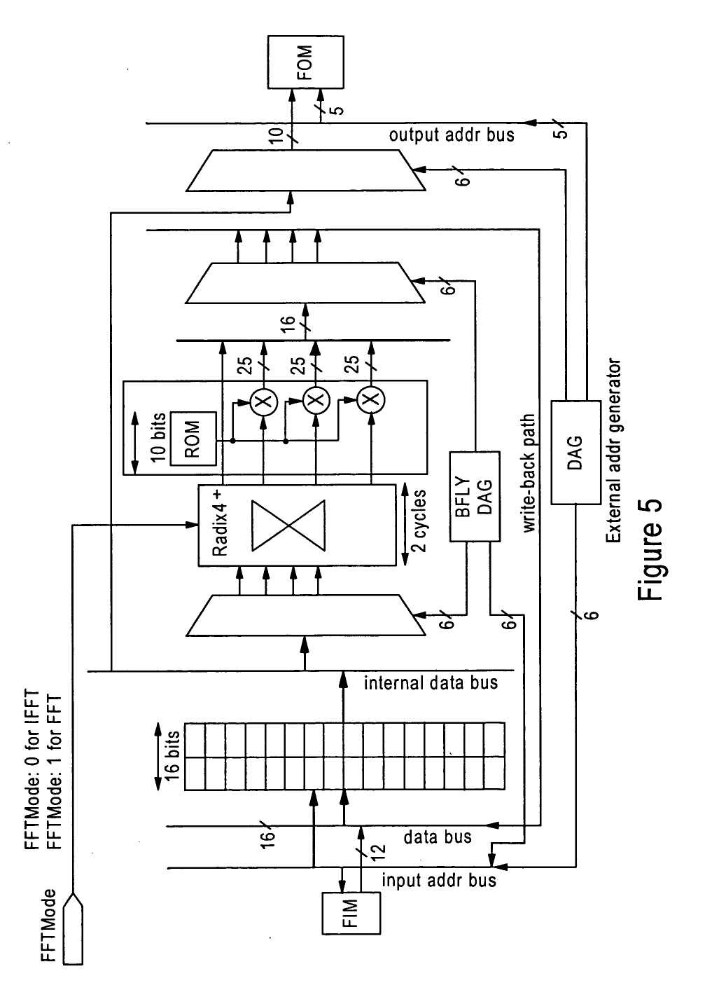

FIG. 5 is a diagram illustrating implementation of the FFT circuit. The 64-point FFT, implemented by 3 stages of a Radix-4 Butterfly, enables sharing of the butterfly element across three stages, reducing circuit area. A Butterfly data address generator (BFLY_DAG), representing an implementation of the memory controller 14, is used to generate appropriate data addresses for the inputs/outputs of the butterfly element 12. Since the inputs to the second stage depend on the outputs of the first stage and the inputs to the third stage depend on the outputs of the second stage, an appropriate data accessing schedule is used, as described above, to make the butterfly unit as fully utilized as possible.

While this invention has been described with what is presently considered to be the most practical preferred embodiment, it is to be understood that the invention is not limited to the disclosed embodiments, but, on the contrary, is intended to cover various modifications and equivalent arrangements included within the spirit and scope of the appended claims.

1. A method in a Fast Fourier Transform (FFT) circuit having at least a Radix-4 butterfly element, the method including:
storing first and second equal portions of a prescribed number of data values in first and second memory portions, respectively, according to a prescribed mapping that ensures the first and second memory portions are accessed for each in-place computation operation;
executing a prescribed number of FFT stages each having a prescribed number of the in-place computation operations relative to the prescribed number of data values, wherein the executing step includes performing each in-place computation operation by:
(1) concurrently accessing an equal number of stored data values from the first memory portion and the second memory portion; and
(2) supplying the accessed data values to the at least Radix-4 butterfly element for calculation of respective calculation results.

2. The method of claim 1, wherein the step of performing each in-place computation includes storing the calculation results in the first memory portion and the second memory portions at memory locations having stored the respective accessed data values.

3. The method of claim 2, wherein the first and second memory portions each are dual-port memory devices, the executing step including accessing the stored data values for a subsequent one of the in-place computation operations concurrently during the storing of the calculation results for said each in-place computation operation.

4. The method of claim 3, wherein the executing step includes performing the in-place computation operations for a first of the FFT stages in a prescribed order based on an input sequence of one of the in-place operations for a second of the FFT stages.

5. The method of claim 4, wherein the executing step further includes initiating the one in-place operation for the second of the FFT stages after having completed the prescribed order of the in-place computation operations relative to the input sequence.

6. The receiver of claim 2, wherein the concurrently accessing step includes accessing, for each clock cycle, a corresponding stored data value from a read port of the first memory portion and a corresponding stored data value from a read port of the second memory portion, the storing step including writing, during said each clock cycle, a corresponding calculation result via a write port of the first memory portion and a corresponding calculation result via a write port of the second memory portion.

7. A Fast Fourier Transform (FFT) circuit comprising:
at least a Radix-4 butterfly element configured for generating calculation results in response to receipt of accessed data values;
first and second memory portions configured for storing first and second equal portions of a prescribed number of data values for in-place computation operations; and
a memory controller configured for storing the first and second equal portions of the prescribed number of data values in the first and second memory portions, respectively, according to a prescribed mapping that ensures the first and second memory portions are accessed for each in-place computation operation, the memory controller configured for executing a prescribed number of FFT stages, each having a prescribed number of the in-place computation operations relative to the prescribed number of data values, based on:
(1) concurrently accessing an equal number of stored data values from the first memory portion and the second memory portion; and
(2) supplying the accessed data values to the at least Radix-4 butterfly element for calculation of the respective calculation results.

8. The FFT circuit of claim 7, wherein the memory controller is configured for storing the calculation results for each in-place computation operation in the first memory portion and the second memory portions at memory locations having stored the respective accessed data values.

9. The FFT circuit claim 8, wherein the first and second memory portions each are dual-port memory devices, the memory controller configured for accessing the stored data values for a subsequent one of the in-place computation operations concurrently during the storing of the calculation results for said each in-place computation operation.

10. The FFT circuit of claim 9, wherein the memory controller configured for causing executing of the in-place computation operations for a first of the FFT stages in a prescribed order based on an input sequence of one of the in-place operations for a second of the FFT stages.

11. The FFT circuit of claim 10, wherein the memory controller is configured for initiating the one in-place operation for the second of the FFT stages after having completed the prescribed order of the in-place computation operations relative to the input sequence.

12. The FFT circuit of claim 8, wherein the memory controller is configured for accessing, for each clock cycle, a corresponding stored data value from a read port of the first memory portion and a corresponding stored data value from a read port of the second memory portion, the memory controller configured for writing, during each clock cycle following generation of calculation results by the at least Radix-4 butterfly, a corresponding calculation result via a write port of the first memory portion and a corresponding calculation result via a write port of the second memory portion.
